(19) United States
(12) Patent Application Publication
(10) Pub. No.: US 2007/0186895 A1
(43) Pub. Date: Aug. 16, 2007

(54) Air cleaner box, intake sound control apparatus, and intake sound control method

(76) Inventor: Daisuke Ochi, Kanagawa (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/699,871

(22) Filed: Jan. 30, 2007

(30) Foreign Application Priority Data
Jan. 31, 2006 (JP) 2006-022196

(51) Int. Cl. F02M 35/02; F16F 15/00

(52) U.S. Cl. 123/198 E; 181/207

(57) ABSTRACT

An intake sound control apparatus disposed in a vehicle is disclosed. The intake sound control apparatus comprises an air cleaner box and an acoustic converter. The air cleaner box includes a through-hole formed separately from the intake path to allow passage of sound from the inside of the air cleaner box to the outside of the air cleaner box. The air cleaner box is disposed in an intake path that communicates between an outside air inlet portion and an intake port of an engine. The acoustic converter is disposed in the air cleaner box and generates a control sound that interferes with the intake sound occurring in the inside of the air cleaner box. An intake sound control method is also disclosed.

### CROSS-REFERENCE TO RELATED APPLICATIONS

This application claims priority from Japanese Patent Application Ser. No. 2006-022196 filed Jan. 31, 2006, the disclosure of which, including its specification, drawings and claims, are incorporated herein by reference in its entirety.

### BACKGROUND

1. Technical Field

The present disclosure relates to an air cleaner box, an intake sound control apparatus, and an intake sound control method.

2. Description of the Related Art

In the past, intake sounds of the motor vehicle were considered undesirable noise to vehicle passengers such that considerable effort was employed to mute such sounds. In recent years, however, an approach has been taken in which certain frequency components of the intake sound of the motor vehicle is used in connection with product differentiation such that vehicle passengers expect to hear a certain sound from the operation of the vehicle. One such known type of apparatus that has been adopted for implementing this technique is disclosed in Japanese Patent Application Laid-Open No. 05-209563. As discussed in this reference, the technique involves using a control sound that interferes with the intake sound that is emanated to an intake path from a speaker, thereby amplifying a desired frequency component of the intake sound to create a specific, recognizable sound.

However, as described and shown in Japanese Patent Application Laid-Open No. 05-209563, to utilize this technique, the size of the speaker has to be increased to secure an acoustic power necessary for tuning the intake sound, thereby leading difficulties in implementing the technique in terms of the layout configuration and packaging concerns. Further, a large amount of power is necessary, and the capacities of components, such as the battery and alternator, have to be increased to obtain the necessary power.

### SUMMARY

An intake sound control apparatus disposed in a vehicle is disclosed. The intake sound control apparatus comprises an air cleaner box and an acoustic converter. The air cleaner box includes a through-hole formed separately from the intake path to allow passage of sound from the inside of the air cleaner box to the outside of the air cleaner box. The air cleaner box is disposed in an intake path that communicates between an outside air inlet portion and an intake port of an engine. The acoustic converter is disposed in the air cleaner box and generates a control sound that interferes with the intake sound occurring in the inside of the air cleaner box. An intake sound control method is also disclosed.

### BRIEF DESCRIPTION OF THE DRAWINGS

Other features and advantages of the present system will be apparent from the ensuing description, taken in conjunction with the accompanying drawings, in which:

FIG. 1 is an schematic drawing of a configuration of an intake sound control apparatus according to an embodiment;

FIG. 2 is an explanatory flow diagram illustrating processing executed by a controller;

FIG. 3 is an explanatory flow diagram illustrating a control signal generation process executed by the controller;

FIG. 4 is an explanatory diagram of map information that may be used for determining the phase of the control sound;

FIG. 5 is an explanatory diagram of map information that may be used for determining the amplitude of the control sound;

FIG. 6 is a flow diagram illustrating a feedback process processed by the controller;

FIG. 7 is a graph showing the relationship between engine speed and sound pressure level;

FIG. 8 is an explanatory view of another embodiment;

FIG. 9 is an explanatory view of another embodiment;

FIGS. 10A and 10B show explanatory views of another embodiment; and

FIG. 12 is an explanatory view of another embodiment.

### DESCRIPTION OF THE PREFERRED EMBODIMENTS

Embodiments of the present invention will be described with reference to the accompanying drawings.

### First Embodiment

An intake path to which an intake sound control apparatus of an embodiment of the disclosure is applied is described as follows.

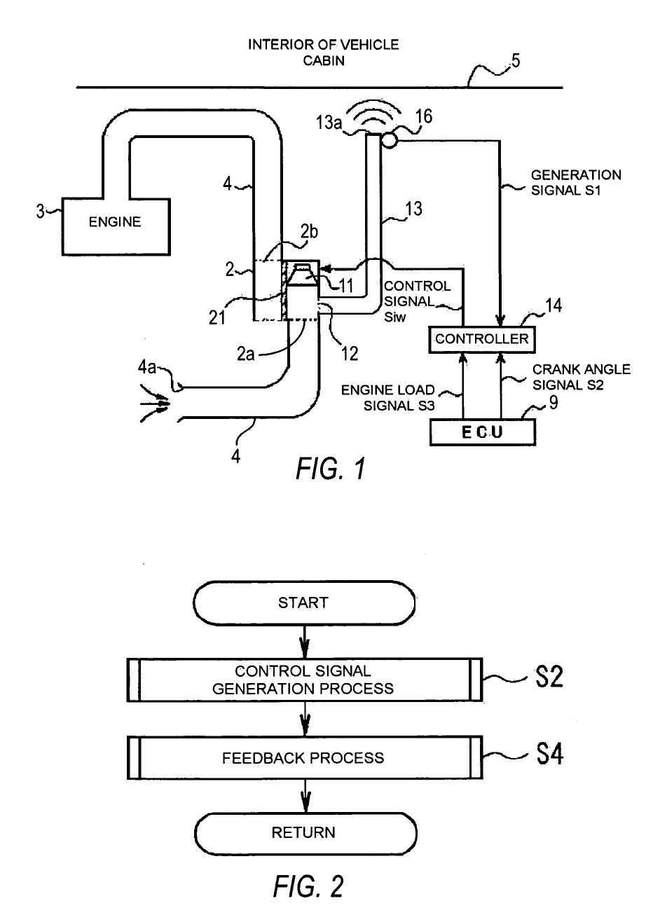

Referring initially to FIG. 1, an intake duct 4 has first and second ends. An outside air inlet port 4a, which is open to outside air, is located at the first end of the intake duct 4. A respective cylinder of an engine 3 is located at the second end of the intake duct 4. An air cleaner box 2 is interposed at the approximate midway point of the inlet duct 4. Thus, the inlet duct 4 and the air cleaner box 2 together comprise the intake path. Intake air passes through the interior of the air cleaner box 2, whereby the intake air is cleaned and is supplied to the engine 3. In conjunction with the inlet operation, the engine 3 acts as an energizing source that causes gases existing in the inlet duct 4 to generate intake pulsations. The intake pulsations act as a sound source for an intake sound. The intake pulsations are pressure fluctuations occurring in gases existing in the inlet duct 4, and comprise intake pulsations of a plurality of frequencies.

The configuration of an intake sound control apparatus which is applied to the intake path 4 will now be described.

An intake sound control apparatus of an embodiment includes a speaker unit 11 that is disposed in the interior of the air cleaner box 2, a waveguide 13, a sensor, a microphone 15, and a controller 14.

As described above, the air cleaner box 2 is positioned at an approximate midway point of the intake path 4. The intake air flows into the air cleaner box 2 from an intake port 2a connected to the inlet duct 4 on the side of the outside air inlet port 4a. Then, the intake air flows out from an intake air outlet port 2b to the inlet duct 4 connected on the side of the engine 3. Thus, the intake port 2a and the intake air outlet port 2b together form a through-hole working as the intake path 4. In the interior of the air cleaner box 2, the intake pulsations propagate from the side of the engine 3 to the side of the outside air inlet port 4a. An air filter 21 is provided at an approximate midway point of the intake path 4 in the interior of the air cleaner box 2, in which the intake air passes through the air filter 21 and is cleaned thereby. With the air filter 21 as a boundary, the space on the side of the engine 3 will be referred to as the “clean side,” and the space on the side of the outside air inlet port 4a will be referred to as the “dust side.” The type of the air filter 21 is not specifically limited in the application of the present invention. For example, the present invention can be applied in a configuration using any one of, for example, conventionally used filters of an oil bath, dry paper, and wet paper types.

The speaker device 11 includes an amplifier unit that amplifies an electrical signal input that is received from the controller 14 (described below). The speaker unit 11 converts the electrical signal input from the amplifier unit to an acoustic wave and emanates the acoustic wave as a control sound. As long as the speaker unit 11 can generate and emanate acoustic waves, the configuration of the speaker unit 11 is not specifically limited, but any one of various speakers, such as electrodynamic, electromagnetic, piezoelectric, and electrostatic types, may be used. In the present embodiment, the speaker device 11 receives necessary power through a connection via a cable to a battery or alternator (not shown) provided externally to the apparatus.

In the present embodiment, the speaker device 11 is disposed on the dust side in the interior of the air cleaner box 2 in a state where an acoustic emission port (speaker surface plane) of the speaker portion opposes or faces the outside air inlet port 4a. A speaker portion of the speaker device 11 corresponds to an acoustic converter of the present embodiment.

A first end of the waveguide 13 communicates to the interior of the air cleaner box 2 through a through-hole 12 provided to the air cleaner box 2, and the waveguide 13 extends therefrom to a vehicle cabin. A second end 13a (or, “cabin side end portion,” as used herebelow) of the waveguide 13 is open toward the vehicle cabin. The through-hole 12 is provided separately from the through-hole that is defined by the intake port 2a and outlet port 2b.

The sensor microphone 15 is disposed near the cabin side end portion 13a of the waveguide 13. The sensor microphone 15 captures a control intake sound emanated from the cabin side end portion 13a, and outputs the control intake sound to the controller 14. The control intake sound is controlled by being interfered with the control sound generated by the speaker unit 11.

The controller 14 includes a microcomputer, an interface circuit, an A/D (analog-digital) converter, a D/A (digital-analog) converter, and a storage medium(s) (a ROM (read-only memory), RAM (random access memory), and/or the like). The controller 14 thus configured is provided externally to the air cleaner box 2. The sensor microphone 15, an engine control unit 9, (“ECU,” hereinbelow), and the speaker device 11, respectively, are connected to the controller 14 through signal lines. A signal (generation signal S1) of the control intake sound is input to the controller 14 from the sensor microphone 15, and a crank angle signal S2 and an engine load signal S3 are also input to the controller 14 from the ECU 9.

The crank angle signal S2 is used to acquire information regarding the rotation speed of the engine 3. The intake pulsations are caused in conjunction with the intermittent flow of intake gases into the cylinder of the engine 3, such that the frequency thereof is responsive to the speed of the engine 3. For instance, in the case of a four-cylinder engine, the sound pressure level of a rotating secondary component is highest. Further, since pulsation generation timing is synchronized with opening a respective intake valve, the phase of the pulsations also correlates with the crank angle signal.

The engine load signal S3 is converted from, for example, a value of a throttle valve opening and a value of a negative pressure of the intake gases. As the engine load increases, (or the throttle valve opening enlarges), the pressure fluctuation level of the intake gases proportionally becomes higher, so that the amplitude of the intake pulsations correlates with the engine load signal.

In accordance with the input crank angle signal S2 and engine load signal S3, the controller 14 calculates the control sound that is used for interference with the intake sound, and outputs a control signal Siw, which generates the control sound, to the speaker device 11. More specifically, a same-phase (in-phase) control sound is generated at the same frequency as a specific frequency component included in the intake sound. Then, the intake sound of the frequency component is amplified, and a reverse-phase control sound is generated at the same frequency as the other specific frequency component, thereby muting the intake sound of the frequency component.

Further, in the present embodiment, in accordance with the control intake sound having been received from the sensor microphone 15, a comparison is performed between a target control intake sound and a control intake sound being generated. If a difference therebetween occurs, then a feedback process is carried out to correct for the control sound that is to be generated.

Examples of the processes of the controller 14 will be described with reference to the flow diagrams of FIGS. 2, 3, and 6. The processes shown in the flow diagram of FIG. 2 are executed by timer interruption in units of a predetermined sampling period of time ΔT set to about 10 msec for example. In the flow diagrams, specific steps for communication are not provided, but the results obtained by calculation processes are serially updated and stored into the storage device. In addition, during the processing, necessary information and programs are read from the storage device as and when necessary.

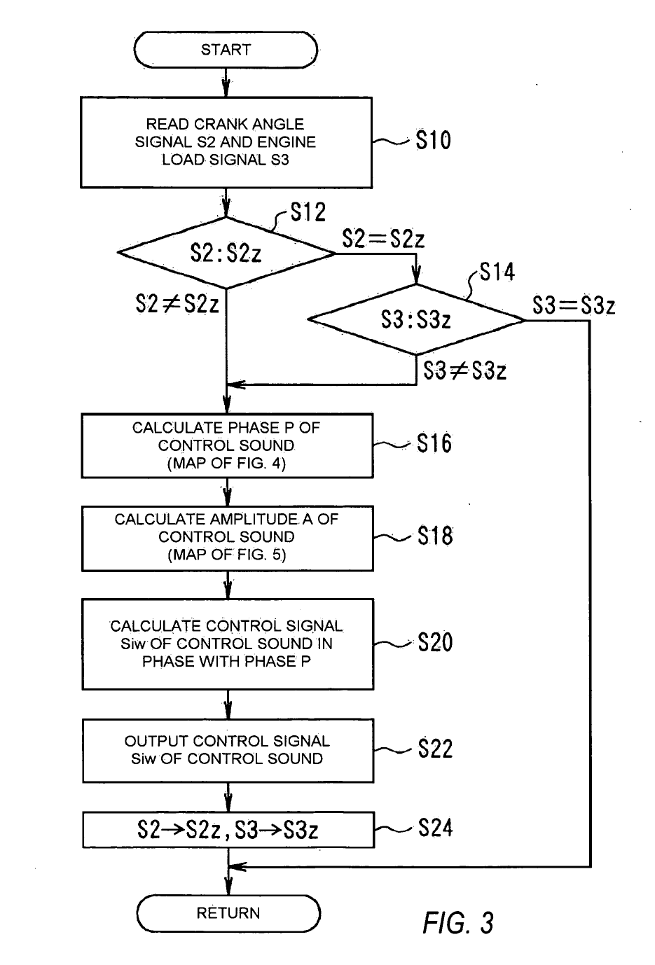

In the processing shown in FIG. 2, a control signal generation process is executed at step S2, and then the processing proceeds to step S4 at which a feedback process is executed. As shown in FIG. 3, which illustrates the control signal generation process, at step S10 a crank angle signal S2 (present crank angle signal S2) and an engine load signal S3 (present engine load signal S3) are read. Then, the processing proceeds to step S12, at which the present crank angle signal S2 having been read, is compared with a crank angle signal S2z that was previously read. If the present crank angle signal S2 and the previous crank angle signal S2z have a same value, then the processing proceeds to step S14. If the present and previous signals S2 and S2z do not have a same value, the processing proceeds to step S16.

At step S14, the present engine load signal S3, having also been presently read, is compared with a previous engine load signal S3z previously read. If the present and previous signals S3 and 3Sz have a same value, then the processing terminates the control signal generation process, and then returns to a main program. Alternatively, if the present and previous signals S3 and 3Sz do not have a same value at step S14, the processing proceeds to step S16.

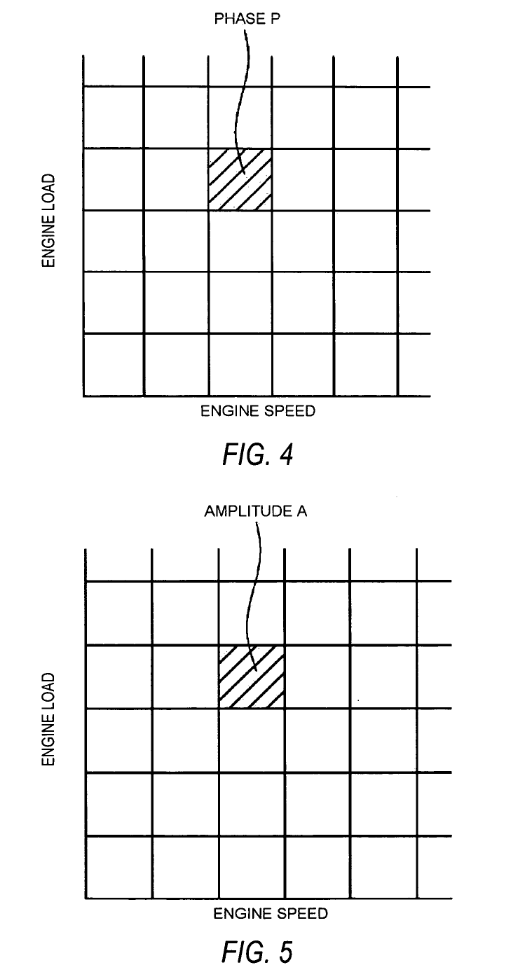

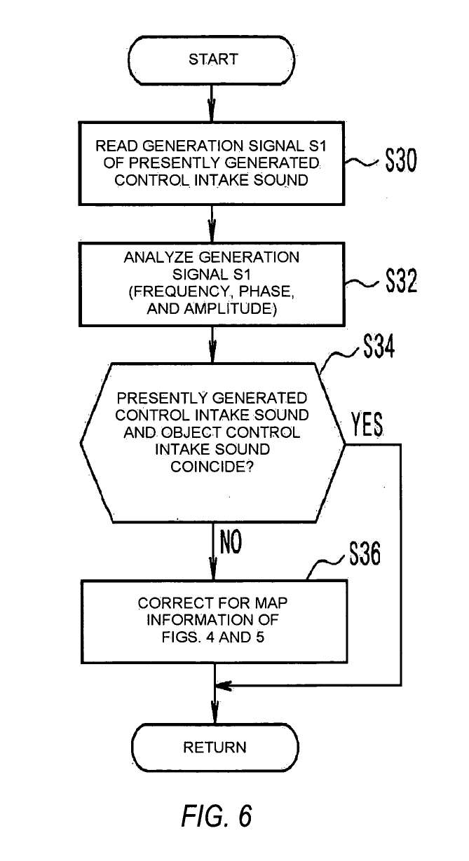

At step S16, a phase P of the control sound is calculated in accordance with a map, such as that which is shown in FIG. 4. Map information shown in FIG. 4 represents the relationship between the present crank angle signal S2 and the present engine load signal S3 and the phase of the control sound to be generated corresponding thereto, and is stored in the storage medium in advance. Once the phase P of the control sound is calculated, the processing subsequently proceeds to step S18, at which an amplitude A is calculated in accordance with a map, such as that which is shown in FIG. 5. Map information shown in FIG. 5 represents the relationship between the present crank angle signal S2 and the present engine load signal S3 and the amplitude to be generated corresponding thereto, and is stored in the storage medium in advance. For the map information, values obtained by experimentation and the like with respect to control sounds for generation of target control intake sounds are used.

After the phase P and amplitude A of the control sound are obtained, the processing then proceeds to step S20, at which time control signal Siw for causing the speaker device 11 to generate a control sound in phase with the phase P is calculated. Subsequently, the processing proceeds to step S22, at which time the calculated control signal Siw is output to the speaker device 11. Then, the processing proceeds to step S24, at which time the present crank angle signal S2 is set to the previous crank angle signal S2z, and present engine load signal S3 is set to the previous engine load signal S3z. Thereafter, the processing returns to the main program.

The feedback process shown in FIG. 2 will now be described. The process is executed through the steps of processing shown in FIG. 6. To begin with, at step S30 a generation signal S1 that is generated in the speaker device 11 and captured by the sensor microphone 15 is read. The processing then proceeds to step S32, at which time a control intake sound that is generated from the generation signal S1 is analyzed.

Subsequently, the processing proceeds to step S34, at which time a comparison is made between the generated control intake sound and a target control intake sound. If the present control intake sound and the target control intake sound coincide, the feedback process is terminated and returns to the main program. Alternatively, if the present control intake sound and the target control intake sound do not match for the reasons that, for example, a phase shift or out-of-phase condition has occurred, or the sound pressure level has not reached a desired value, processing proceeds to step S36. At step S36, the map information of FIG. 4 for calculation of the phase P of the control sound and the map information of FIG. 5 for calculation of the amplitude A of the control sound are corrected for in accordance with offset amounts in phase and amplitude between the generated control intake sound and the target control intake sound.

Effects and advantages of the embodiment described above will be described herebelow.

Upon operation of the engine 3, intake pulsations occur in conjunction with the intake operation of the engine 3, and propagate to gases on the inside of the inlet duct 4. The controller 14, which has detected a change in the rotation speed upon operation of the engine 3, outputs a control signal corresponding to the intake pulsations to the speaker device 11. In response to the control signal, the speaker device 11 emanates a control sound in the air cleaner box 2. The control sound interferes with intake sound in the air cleaner box 2. Accordingly, the intake sound propagates as a control intake sound amplified or muted by the control sound from an interfered area through the waveguide 13 and the inlet duct 4. Then, the control intake sound is emanated from the respective cabin side end portion 13a and outside air inlet port 4a. In this event, the control sound is amplified in the interior of the air cleaner box 2, so that the output of the control sound can be attenuated, thereby achieving, for example, physical compactness of the speaker device 11 and power conservation. The control intake sound is propagated into the vehicle cabin through the waveguide 13 and the inlet duct 4, that respectively have different transfer characteristics. Accordingly, even the control intake sound less propagatable through the one path is propagatable into the vehicle cabin through the other path.

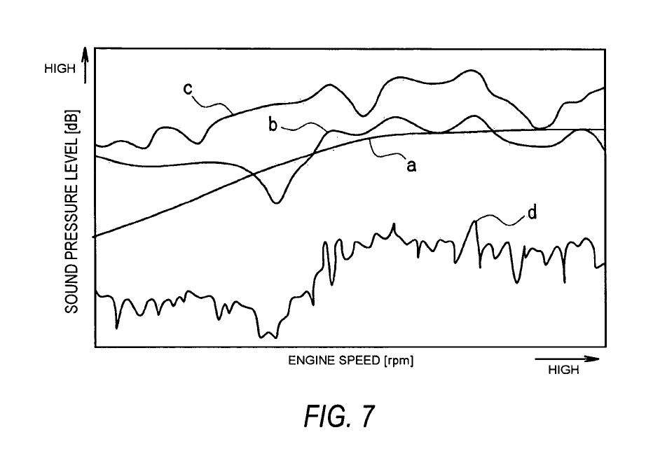

FIG. 7 is a graph showing the relationship between the control intake sound (predetermined order ratio component), which is emanated from the cabin side end portion 13a of the waveguide 13, and the engine speed. In the graph, a line a represents a case where a control sound is generated in accordance with the map information of the present embodiment; a line b represents a case where no control sound is generated from the speaker device 11; a line c represents a case where a control sound in phase with the intake sound is generated from the speaker device 11; and a line d represents a case where a control sound having a reverse phase with respect to the intake sound is generated. As shown in the graph, in comparison with the case only with the intake sound represented by the line b, when the in-phase control sound is generated, it is amplified; and when the reverse-phase control sound is generated, it is muted. In the present embodiment, the mode of the in-phase/reverse-phase control sound and the amplitude of the control sound are regulated, and the control intake sound whose sound pressure level increases in proportion to the increase of the engine speed is generated, whereby a desired sporty sound giving user a vivid high-speed feeling is produced.

Further, according to the present embodiment, the waveguide 13 is provided to emanate the control intake sound toward the vehicle cabin from a proximity position, so that high transfer efficiency of the intake sound can be attained. For this reason, the level of the intake sound for propagation to the vehicle cabin can be increased evenly with the intake sound less amplified. Consequently, the capacity of the speaker device 11 can be reduced, and hence the energy consumption and the size of the speaker device 11 can be reduced, so that layout and/or packaging requirements in the air cleaner box 2 can easily be satisfied. Further, by providing the waveguide 13, the sound pressure level of the control intake sound does not have to be increased very much, if at all. Consequently, the level of the control intake sound emanated from the outside air inlet port 4a can be reduced, and implementability is high.

In the present invention, however, the waveguide 13 is not an indispensable component. The configuration may be such that the waveguide 13 is not provided, but the control intake sound is emanated from the through-hole 12 provided to the air cleaner box 2. Even in this case (configuration), advantages can be obtained in that an emanation sound from the outside air inlet port 4a which is located close to a grille of the vehicle and through which sounds or noise are likely to transfer to the outside of the vehicle cabin, is reduced, so that noise outside the vehicle is reduced.

While the present embodiment has been described as above, the present invention is not limited for application to the embodiment described above.

### Second Embodiment

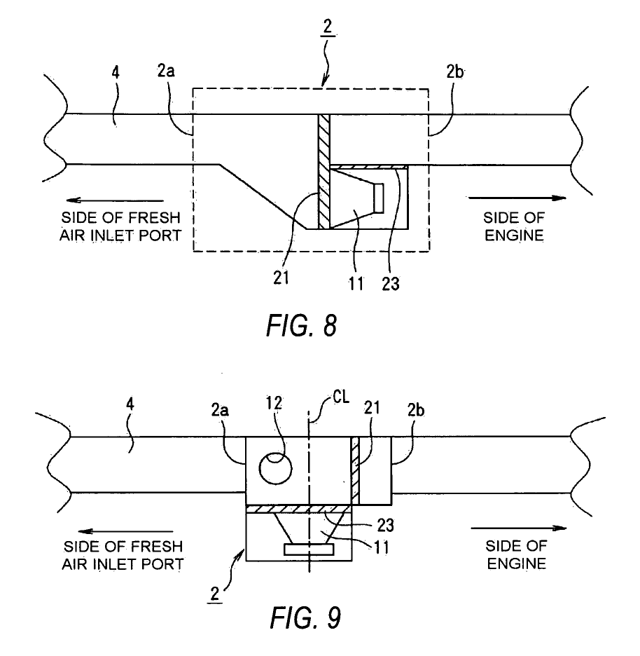

In the configuration shown in FIG. 1, for example, although the speaker device 11 is disposed on the dust side, it is understood that the speaker device 11 may be disposed on the clean side. In the configuration shown in FIG. 8, the air cleaner box 2 is formed with a relatively large clean side, while the dust side has a shape that is gradually reduced in diameter toward side of the outside air inlet port 4a. The relatively larger clean side includes a filter 23. The filter 23 partitions the relatively larger clean side into a space that is in communication with the intake air outlet port 2b and a space that is isolated from the intake air outlet port 2b. The speaker device 11 is disposed in the isolated space. The speaker device 11 is disposed such that the speaker surface plane opposes the outside air inlet port 4a, in which the control sound emanated from the speaker device 11 is propagated to the dust side through the air filter 21. The air filter 21 and filter 23 correspond to partition members of the present embodiment.

Filter 23 may provide some protection for preventing damaged parts of the speaker device, even when the speaker device 11 is disposed on the clean side, from being drawn into the engine 3. However, since the temperature on clean side is typically much higher than on the dust side, the speaker device 11 is preferably disposed on the dust side to prevent any adverse effects on the speaker device due to heat.

The orientation of the speaker device 11, as specifically shown in FIGS. 1 and 8, is not limited to that which is shown therein. In other words, while FIGS. 1 and 8 both illustrate that the speaker surface plane is directed to oppose or face the intake port 2a of the air cleaner box 2, this orientation is not required. For example, as shown in FIG. 9, in the air cleaner box 2, the large dust side is formed in which the filter 23 partitions the dust side into a space communicating with the air filter 21 and the intake port 2a and a space isolated therefrom. In the isolated space, the speaker device 11 is disposed such that the speaker surface plane is oriented to face the space that communicates with the air filter 21 and the intake port 2a, where the control sound travels through the filter 23 and then interferes the intake sound. Further, in the configuration shown in FIG. 9, the through-hole 12 is provided closer to the side of the outside air inlet port 4a than to the speaker centroid (acoustic centroid) of the speaker device 11, and the waveguide 13 is provided therethrough. In FIG. 9, CL denotes a centerline of the speaker device 11.

As described above, the orientation of the speaker device 11 is not limited as long as acoustic waves can emanate to intake pulsations inside the air cleaner box 2. However, in the case where, as shown in FIGS. 1 and 8, the speaker surface plane is directed toward the side of the outside air inlet port 4a, the traveling direction of the control acoustic wave is generally parallel to the traveling direction of the intake pulsations generated from the engine side, so that desired control is facilitated.

Further, with the through-hole 12 provided closer to the side of the inlet duct 4 than to the speaker centroid, the control intake sound after interference by the control sound, can be guided to the outside of the air cleaner box 2. However, if the through-hole 12 was provided closer to the engine side than to the speaker centroid, an undesired result may occur. More specifically, the intake sound before being interfered with by the control sound could be derived as it is to the outside of the air cleaner box 2. That is, a reflected wave, and/or the like, interferes with the control sound, and hence the control intake sound shifts in phase from the target control intake sound could be derived as it is to the outside of the air cleaner box 2.

Further, as shown in FIG. 9, the filter 23 is provided in the configuration where the speaker device 11 is positioned on the dust side. However, even in this case, foreign matter present in the outside air is prevented from hitting the speaker surface plane of the speaker device 11, thereby making it possible to prevent occurrence of undesirable noise and/or failure or malfunction of the speaker device 11.

The shape of the waveguide 13 is not limited to the embodiment described above. It is understood that the waveguide 13 may have any suitable configuration, as those skilled in the art will recognize.

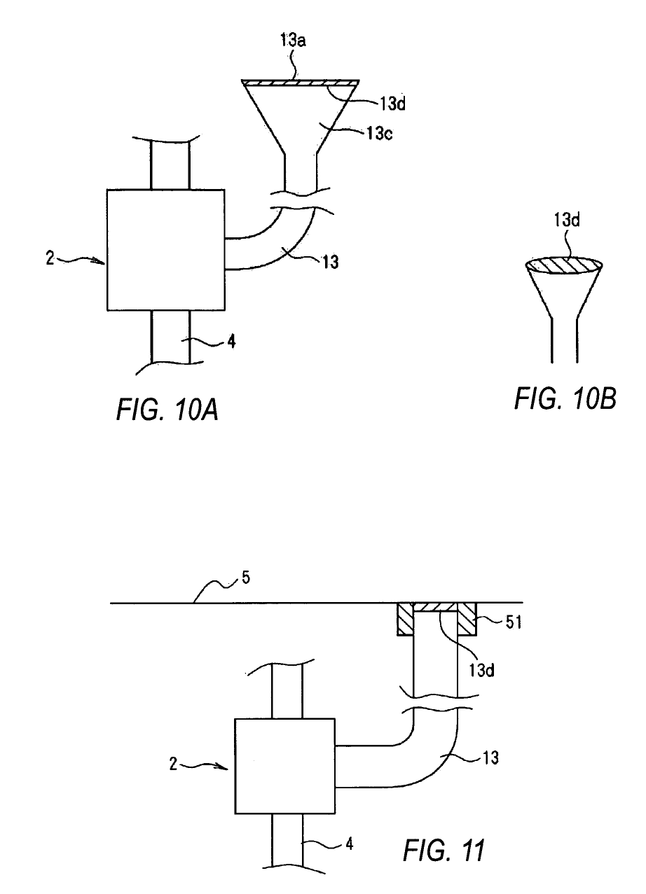

By way of example, the embodiment shown in FIG. 10A includes a flare portion 13c having the shape in which a portion from waveguide 13 gradually enlarges as the waveguide progress toward the cabin side end portion 13a. Further, as shown in FIG. 10B, a vibration membrane 13d is provided in such a manner as to close a cross sectional plane of the cabin side end portion 13a. In this manner, as the cabin side end portion 13a is wider in diameter as compared to waveguide 13, the control sound does not experience, for example, open-end reflection in the vicinity of the cabin side end portion 13a, but various frequency components are efficiently emanated, resulting in an amplification effect. Consequently, vivid, powerful sounds may be propagated into the vehicle cabin. The amplification effect is further enhanced by the vibration membrane 13d provided on the cabin side end portion 13a. Further, the vibration membrane 13d advantageously prevents outside air from being drawn into the intake path from the cabin side end portion 13a, thereby making it possible to prevent deterioration of engine combustion efficiency.

FIG. 11 shows a configuration in which the cabin side end portion 13a is to a dash panel 5. An elastic member 51 having a shape that generally surrounds an outer periphery of the cabin side end portion 13a is adhered to the dash panel 5, and the cabin side end portion 13a is connected to the dash panel 5 via the elastic member 51. Further, similar to the configuration shown in FIG. 10, the vibration membrane 13d closing the cross sectional plane of waveguide 13 is mounted to the cabin side end portion 13a. When the cabin side end portion 13a is not connected to the dash panel 5, but a clearance is provided between the cabin side end portion 13a and the dash panel 5, the emanated control intake sound tends to diffuse, thereby reducing the energy density and the efficiency of transmitting to the dash panel 5. Accordingly, the dash panel 5 is connected in the manner as described above thereby permitting energy of the emanated sound in a concentrated state to transmit through the dash panel 5, so that the transmittance efficiency is high and hence the level of the composite sound propagating into the vehicle cabin is high. Further, since intake gases are drawn from the cabin side end portion 13a similar as in the configuration in which the vibration membrane 13d is provided, adverse effects on combustion in the engine may be avoided.

Further, in any one of the embodiments described above, the amplifier unit of the speaker device 11 may be disposed in the interior of the air cleaner box 2. However, as long as at least the speaker device 11 is disposed in the interior of the air cleaner box 2, the amplifier unit may alternatively be disposed in the exterior of the air cleaner box 2. However, since the amplifier unit is relatively large in size, it is preferable that the amplifier unit be disposed in the interior of the air cleaner box 2. Further, while it is contemplated that speaker device 11 may be electrically activated, it is understood that other activation mechanisms may be employed. For example, speaker device 11 may also be activated by use of a hydraulic activation device so as to cause a vibration membrane to vibrate.

Further, the processes executed by the controller 14 in the embodiments are examples of the present invention, and the present invention is not limited to the embodiments. For example, the feedback process is not indispensable for the processing configuration of the present invention, and may be omitted. Further, the sound collection position of the sensor microphone 15 is not limited to the above described. For example, the control intake sound may be collected in a portion closer to the interfered area, and the evaluation may be made in accordance with the collection result.

What is claimed is:

1. An air cleaner box assembly that is disposed in an intake path communicating between an outside air inlet port and an intake port of an engine and that incorporates an air filter, the air cleaner box assembly comprising:
an air cleaner box having a through-hole formed separately from the intake path to allow passage of sound from the inside of the air cleaner box to the outside of the air cleaner box; and
an acoustic converter that is disposed in the air cleaner box, wherein the acoustic converter generates a control sound that interferes with intake sound occurring in the inside of the air cleaner box.

2. An intake sound control apparatus disposed in a vehicle, the apparatus comprising:
an air cleaner box that is disposed in an intake path communicating between an outside air inlet port and an intake port of an engine, wherein the air cleaner box incorporates an air filter and a through-hole formed separately from the intake path to allow passage of sound from the inside of the air cleaner box to the outside of the air cleaner box; and
an acoustic converter that is disposed in the air cleaner box, wherein the acoustic converter generates a control sound that interferes with intake sound in the inside of the air cleaner box.

3. An intake sound control apparatus according to claim 2, comprising a waveguide having a first end communicating with the inside of the air cleaner box through the through-hole and a second end that is open toward a vehicle cabin.

4. An intake sound control apparatus according to claim 2, wherein, as viewed from a direction perpendicular to the intake path, the through-hole is provided in either a position overlapping with the acoustic converter or a position that is closer to the side of the outside air inlet port than to the acoustic converter.

5. An intake sound control apparatus according to 3, wherein the second end of the waveguide is connected to a dash panel via an elastic member.

6. An intake sound control apparatus according to claim 3, wherein the waveguide includes a flare unit that widens in diameter toward the second end that is open toward the vehicle cabin.

7. An intake sound control apparatus according to claim 5, wherein the waveguide includes a flare unit that widens in diameter toward the second end that is open toward the vehicle cabin.

8. An intake sound control apparatus according to claim 7, wherein the waveguide includes a vibration member that closes a cross section thereof and that vibrates along a direction that extends outwardly from the cross section.

9. An intake sound control apparatus according to claim 3, wherein the waveguide includes a vibration member that closes a cross section thereof and that vibrates along a direction that extends outwardly from the cross section.

10. An intake sound control apparatus according to claim 2, further comprising an acoustic emanation port disposed in the acoustic converter, wherein the acoustic emanation port is disposed toward the outside air inlet port.

11. An intake sound control apparatus according to claim 2, wherein the acoustic converter is disposed in a space of the air cleaner box and wherein the space is provided in a position that is closer to a side of the outside air inlet port than the air filter.

12. An intake sound control apparatus according to claim 2, wherein the acoustic converter further comprises a partition member that partitions the air cleaner box into a first space where the acoustic converter is disposed and a second space that is formed to permit at least part of the control sound generated by the acoustic converter to propagate thereto.

13. An intake sound control method, comprising:
generating a control sound in the inside of an air cleaner box so as to interfere with an intake sound in the inside of the air cleaner box that is disposed in an intake path communicating between a outside air inlet port and an intake port of an engine;
propagating sounds in the inside of the air cleaner box to the outside of the air cleaner box through a through-hole formed therein that is separate from the intake path.

14. An intake sound control apparatus, comprising:
an air cleaner means that is disposed in an intake path communicating between an outside air inlet port and an intake port of an engine, wherein the air cleaner means incorporates a through-hole formed separately from the intake path to allow passage of sound from the inside of the air cleaner means to the outside of the air cleaner means; and
a control sound generation means that is incorporated in the air cleaner means, wherein the control sound generation means generates a control sound that interferes with an intake sound in the inside of the air cleaner means.
